(19) United States
(12) Patent Application Publication
(10) Pub. No.: US 2024/0174284 A1
(43) Pub. Date: May 30, 2024

(54) STEERING SHAFT WITH ALIGNMENT MECHANISM DISPOSED IN AN END THEREOF TO FACILITATE ALIGNED FIXATION WITH A CLAMP YOKE

(71) Applicant: Steering Solutions IP Holding Corporation, Saginaw, MI (US)

(72) Inventors: Michael E. Partyka, Saginaw, MI (US); Bruce D. Kniebbe, Birch Run, MI (US); Thomas M. Finney, Midland, MI (US); David G. Matousek, Bay City, MI (US)

(21) Appl. No.: 18/519,541

(22) Filed: Nov. 27, 2023

Related U.S. Application Data
(60) Provisional application No. 63/428,169, filed on Nov. 28, 2022.

(51) Int. Cl. B62D 1/20; B62D 3/12

(52) U.S. Cl. CPC B62D 1/20; B62D 3/123

(57) ABSTRACT

A steering shaft assembly includes a steering shaft extending along a central longitudinal axis between opposite first and second end portions terminating at respective first and second ends. A recessed pocket extends axially into the first end. The first end portion is configured for receipt in a through bore of a clamp yoke. A flag device has a body configured for receipt in the recessed pocket and a flag extending radially outwardly from the body. The flag is configured to obstruct a fastener opening in the clamp yoke until the steering shaft is inserted into the through bore to a predetermined insertion position.

### CROSS-REFERENCE TO RELATED APPLICATION

This application claims the benefit of U.S. Patent Application Ser. No. 63/428,169, filed Nov. 28, 2022, which is incorporated herein by reference in its entirety.

### FIELD OF THE INVENTION

This disclosure generally relates to steering column assemblies and, more particularly, to steering column assemblies having a shaft fixed to a clamp yoke.

### BACKGROUND

A typical assembly operation for an automobile includes the assembly of a vehicle body and chassis in different locations. In one or more locations, the vehicle body and the chassis are joined and the vehicle body is assembled onto the chassis. One of the systems that needs to be connected after the vehicle body and chassis are joined is a steering shaft, also referred to as intermediate shaft, wherein the intermediate shaft is coupled with a component of a steering system, such as to a steering gear or to a rack and pinion.

To couple the intermediate shaft with the component of the steering system, an end of the intermediate shaft is typically inserted into a clamp yoke, whereupon a pinch bolt is fastened to draw the clamp yoke into fixed relation with the end of the intermediate shaft. It is important that the intermediate shaft be properly inserted to the full axial extent relative to the clamp yoke and rotationally aligned relative to the clamp yoke. Complicating proper assembly of the intermediate shaft is the generally tight space within which an assembler must work, in addition to potentially poor lighting, and having to move with the vehicle, during coupling of the intermediate shaft, while the vehicle is being transferred along an assembly line, among other complicating factors.

### SUMMARY

In accordance with one aspect of the disclosure, a steering shaft assembly includes a steering shaft extending along a central longitudinal axis between opposite first and second end portions terminating at respective first and second ends. A recessed pocket extends axially into the first end. The first end portion is configured for receipt in a through bore of a clamp yoke. A flag device has a body configured for receipt in the recessed pocket and a flag extending radially outwardly from the body. The flag is configured to obstruct a fastener opening in the clamp yoke until the steering shaft is inserted into the through bore to a predetermined insertion position.

In accordance with another aspect of the disclosure, a steering shaft and clamp yoke assembly includes a clamp yoke having an annular wall with a through bore and a fastener opening configured for receipt of a clamp fastener therein. A steering shaft extends along a central longitudinal axis between opposite first and second end portions terminating at respective first and second ends, with a recessed pocket extending axially into the first end. The first end portion is configured for receipt in the through bore of the clamp yoke. A flag device has a body configured for receipt in the recessed pocket and a flag extending radially outwardly from the body. The flag is configured to obstruct the fastener opening until the steering shaft is inserted into the through bore to a predetermined insertion position.

These and other advantages and features will become more apparent from the following description taken in conjunction with the drawings.

### BRIEF DESCRIPTION OF THE DRAWINGS

The subject matter that is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a perspective view of motor vehicle including a steering shaft assembly constructed in accordance with an aspect of the disclosure;

FIG. 1A is a perspective view of a steering shaft assembly of the motor vehicle of FIG. 1;

FIG. 2 is a fragmentary perspective view of the steering shaft assembly of FIG. 1A;

FIG. 2A is an exploded view of FIG. 2;

FIG. 3 is a fragmentary side view of the steering shaft assembly and a clamp yoke illustrating an initial stage of inserting the steering shaft assembly into the clamp yoke;

FIGS. 4 through 5A are similar views to FIG. 3 illustrating progressing intermediate stages of inserting the steering shaft assembly into the clamp yoke;

FIG. 6 is a view similar to FIG. 3 illustrating the steering shaft assembly fully inserted into the clamp yoke to a predetermined axial extent of finished assembly;

FIG. 7 is an end view looking along arrow 7 of FIG. 6, along a central longitudinal axis of the steering shaft assembly;

FIG. 8 is a top plan view looking along arrow 8 of FIG. 6;

FIG. 9 is a perspective view of a flag device of a steering shaft assembly in accordance with another aspect of the disclosure;

FIG. 10 is a view similar to FIG. 3 illustrating an initial stage of insertion of the steering shaft assembly with the flag device of FIG. 9 into a clamp yoke;

FIG. 11 is a view similar to FIG. 6 illustrating the steering shaft assembly of FIG. 10 fully inserted into the clamp yoke to a predetermined axial extent of finished assembly;

FIG. 12 is a view similar to FIG. 9 of a flag device of a steering shaft assembly in accordance with another aspect of the disclosure;

FIG. 12A is a view similar to FIG. 12 of a flag device of a steering shaft assembly in accordance with another aspect of the disclosure; and

FIG. 13 is a cross-sectional view of the flag device of FIG. 12 shown inserted into an end of an intermediate shaft assembly.

### DETAILED DESCRIPTION

Referring now to the Figures, the present disclosure will be described with reference to specific steering shaft assembly and clamp yoke embodiments. It is to be understood that the disclosed embodiments are merely illustrative of the present disclosure and may be embodied in various and alternative forms. Various elements of the disclosed embodiments may be combined or omitted to form further embodiments of the present disclosure. The Figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

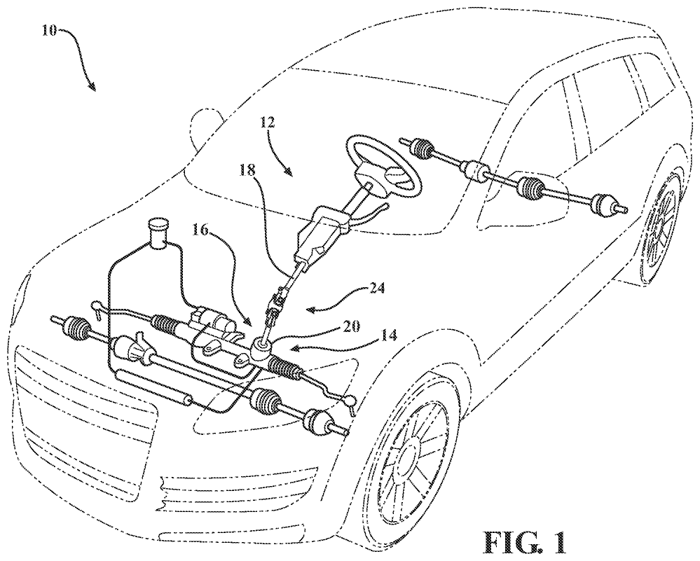

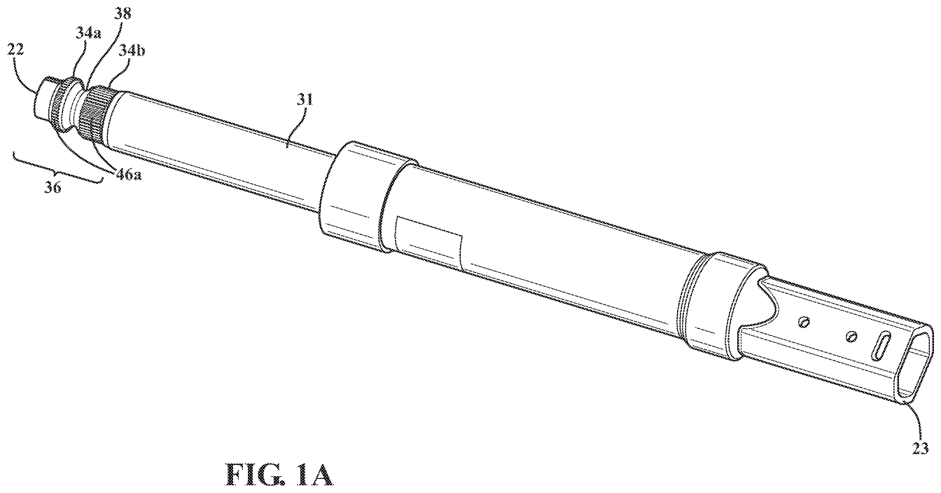

FIG. 1 illustrates a motor vehicle 10 having a steering column assembly 12 operably coupled to a steering gear assembly 14 by a steering shaft assembly, such as an intermediate shaft assembly, and referred to hereafter as intermediate shaft 16, constructed in accordance with an aspect of the disclosure. The intermediate shaft 16 is constructed to facilitate assembly of the intermediate shaft 16 in proper rotational and axial orientation in expedient, reliable fashion relative to a lower end 18 of the steering column assembly 12 and relative to a member, such as a pinion shaft 20, of the steering gear assembly 14 during assembly of the motor vehicle 10.

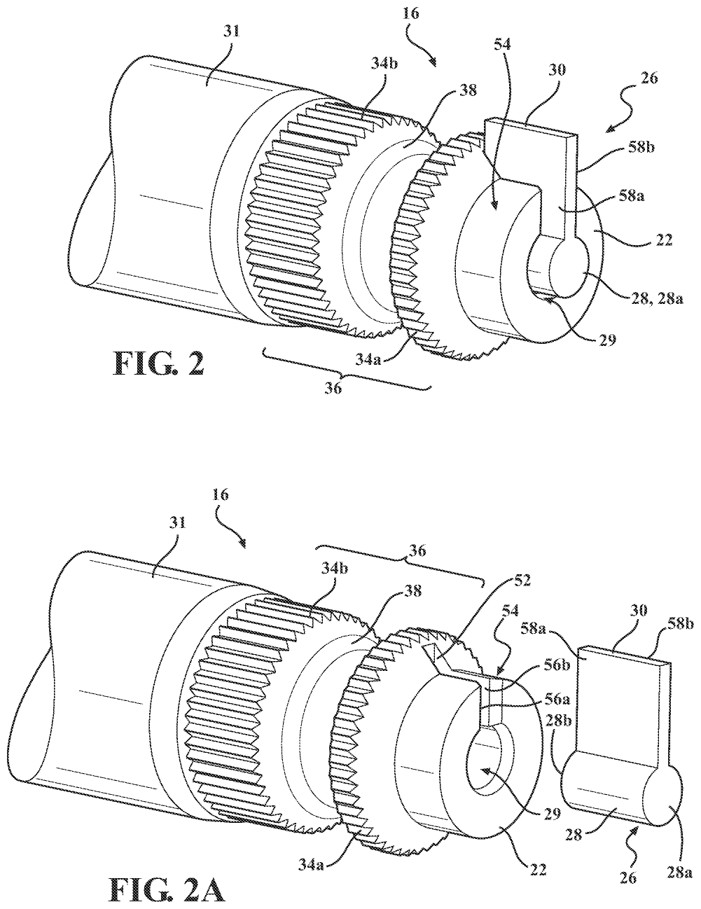

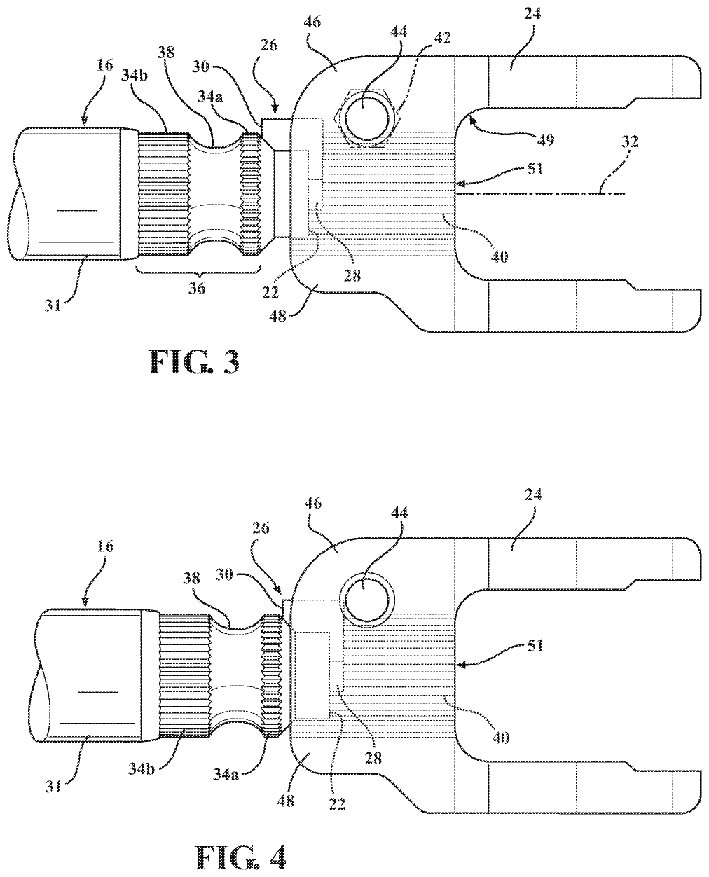

During assembly of the motor vehicle 10, an upper end portion, extending to an upper end 22 (FIG. 2A), of the intermediate shaft 16 is attached to a clamp yoke 24, wherein clamp yoke 24 is fixedly attached to the lower end 18 of the steering column assembly 12. It is important to make sure the rotational orientation and axial extent of axial insertion of the intermediate shaft 16 relative to the clamp yoke 24 is proper and complete, such that the intermediate shaft 16 is fully assembled in clamped relation to the clamp yoke 24 to a predetermined axial extent (position) and rotational orientation. In FIGS. 3 through 6, a progressive sequence of assembly of the upper end 22 of the intermediate shaft 16 to the clamp yoke 24 is illustrated, with FIGS. 3 through 5A illustrating progressive partial assembly positions of the intermediate shaft 16 to the clamp yoke 24, and FIG. 6 illustrating a full and proper assembly of the intermediate shaft 16 to the clamp yoke 24. To facilitate attaining the proper rotational orientation and axial extent of axial insertion of the intermediate shaft 16 relative to the clamp yoke 14, the intermediate shaft 16 has an indicator member, also referred to as flag device 26, coupled, also referred to as attached, thereto. The flag device 26 can both visually and tactilely facilitate assist in making a proper connection of the intermediate shaft 16 to the clamp yoke 24. The flag device 26 has a main segment, also referred to as body 28, sized for receipt in an aperture, also referred to as bore or recessed pocket, referred to hereafter as pocket 29, extending axially into the upper end of a shaft 31 of the intermediate shaft 16, and an indicator projection, also referred to as flange, blocking segment, cog, or flag 30, extending radially outwardly from the body 28. Pocket 29 can be formed as a blind bore or a through bore, such as shown in FIG. 13, as desired. If pocket 29 is a through bore, shaft 31 can be provided as a tube, such as an extruded tube, by way of example and without limitation.

With reference to FIG. 1A, the intermediate shaft 16 includes the shaft 31 that extends along a central longitudinal axis 32 between the upper end, also referred to as first end 22, and an opposite lower end portion having a lower end, also referred to as second end 23. The first end 22 has a first end region 36 including a male spline region, shown as including a pair of male splines 34a, 34b axially spaced from one another by a concave annular groove 38. The male splines 34a, 34b are configured for interdigitated coupling with a female spline 40 (FIG. 3A) of the clamp yoke 24, with the male splines 34a, 34b and female spline 40 locking the intermediate shaft 16 and the clamp yoke 24 in fixed relation with one another to prevent relative axial and relative rotational movement therebetween. Clamped fixation of the clamp yoke 24, facilitated by a clamp fastener, such as a threaded bolt 42, tightened within a through opening, also referred to as aperture or fastener opening or pair of aligned fastener openings 44, in spaced apart flanges, also referred to as ears 46, maintains the male and female splines 34a, 34b, 40 in fixed relation with one another, reliably preventing relative rotational and axial movement between the intermediate shaft 16 and the clamp yoke 24.

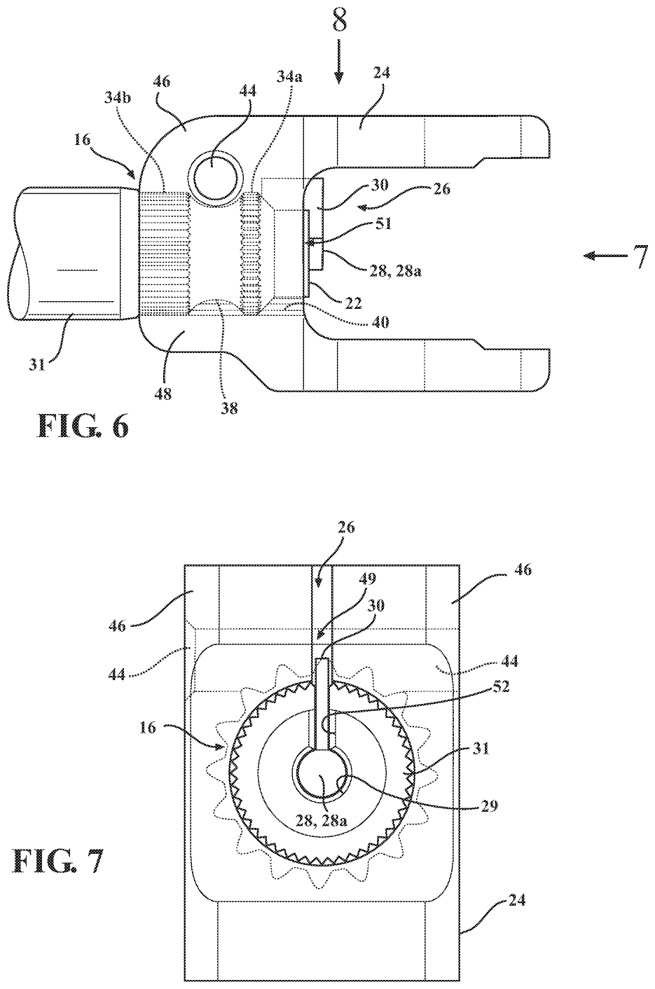

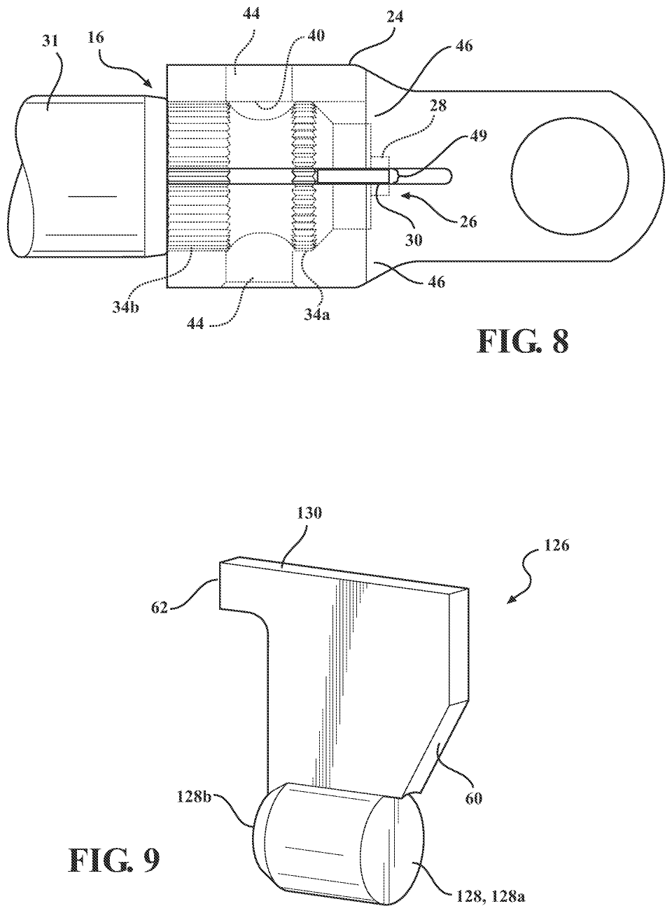

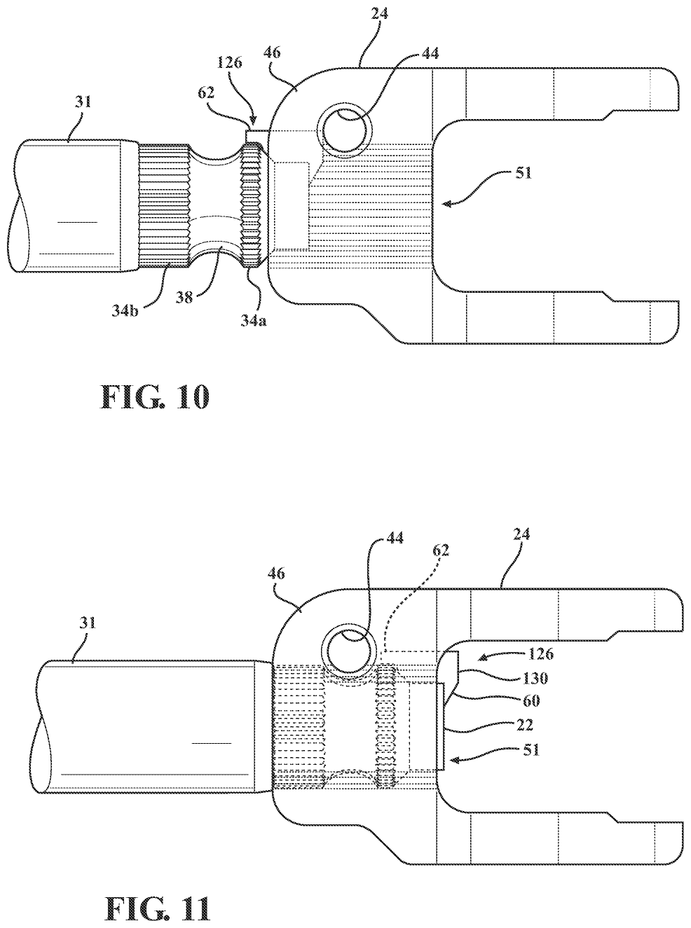

The clamp yoke 24 can be provided having an annular wall 48 with a flag gap, also referred to as through split 49 (FIG. 7) extending between the ears 46, and a through bore 51 including the female spline 40. Ears 46 extend radially outwardly from the wall 48 immediately adjacent the through split 49. The fastener openings 44 extend through the ears 46 for receipt of the clamp fastener 42 (FIG. 3) therethrough. The clamp fastener 42 is fastened to draw the ears 46 toward one another, thereby bringing the clamp yoke 24 into fixed, clamped relation to the shaft 31, thereby preventing relative movement between the shaft 31 and the clamp yoke 24.

As best seen in FIG. 2A, the pocket 29 extends axially from the upper end 22 into the steering shaft 31 along the central longitudinal axis 32. A slot 52 extends radially outwardly from the pocket 29 through an outer surface 54 of the steering shaft 31. The pocket 29 and slot 52 are best shown in FIG. 7 as being generally key-hole in shape, as viewed looking along the central longitudinal axis 32. The body 28 of the flag device 26 is configured for receipt in the pocket 29, with the pocket 29 shown in a non-limiting embodiment as being generally cylindrical, and the body 28 being generally cylindrical for a close fit therein. When the body 28 is disposed in the pocket 30, the flag 30 extends radially outwardly from the body 28 through the slot 52. The slot 52 is bounded by opposite sidewalls 56a, 56b, wherein the sidewalls 56a, 56b are configured to confront opposite sides 58a, 58b of the flag 30, respectively, to prevent the flag device 26 from rotating relative to the steering shaft 16 about the central longitudinal axis 32. In the non-limiting embodiment, the pocket 29 extends along the central longitudinal axis 32 in coaxial alignment with the central longitudinal axis 32. In further illustration of the non-limiting embodiment, as best shown in FIGS. 2-6, an exposed end 28a of the body 28 and flag 30 extend axially beyond and outwardly from the upper end 22. Upon inserting an insertion end 28b of the flag device 26 into the recessed pocket 29 and the slot 52, the flag device 26 closes off the recessed pocket 29 and slot 52 against ingress of water, thereby reducing the potential for corrosion.

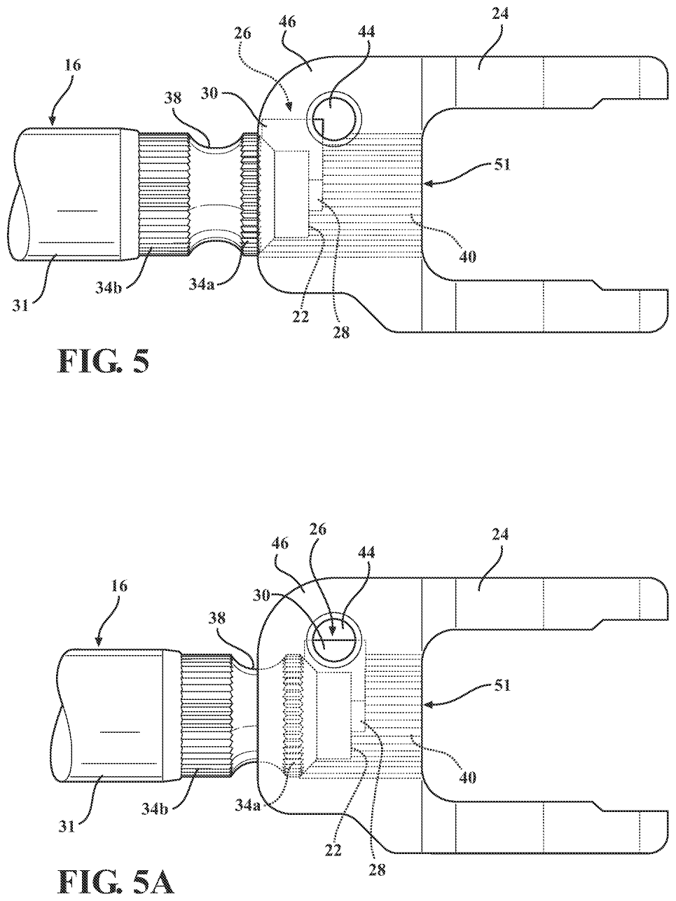

During assembly of the intermediate shaft 16 to the clamp yoke 24, as shown in sequential axial insertion of the intermediate shaft 16 into the through bore 51 of the clamp yoke 24 in FIGS. 3 through 6, the flag 30 is slidably received between the ears 46 and within the through split 49, whereupon the flag 30 is configured to at least partially obstruct the fastener opening(s) 44 in the clamp yoke 24 as long as the intermediate shaft 16 is less than fully assembled to the clamp yoke 24, as shown in FIG. 5, thereby preventing the clamp fastener 42 from being able to be inserted through the fastener openings 44. Only upon the intermediate shaft 16 being inserted axially into the through bore 51 to a fully inserted, predetermined insertion position, also referred to as a fully assembled position, as shown in FIG. 6, whereupon the entire contour of the concave annular groove 38 becomes aligned with the fastener openings 44 and the flag 30 is completely removed from obstructing the fastener opening(s) 44, is the clamp fastener 42 able to be inserted through the fastener openings 44. Accordingly, the flag 30 prevents premature insertion of the clamp fastener 42 through the fastener opening(s) 44, thereby preventing an improper coupling of the intermediate shaft 16 to the clamp yoke 24.

In FIG. 9, a flag device 126 constructed in accordance with another aspect of the disclosure is shown, wherein the same reference numerals, offset by a factor of 100, are used to identify like features of the flag device 126. The flag device 126 has a body 128 with an exposed end 128a and an insertion end 128b, and a flag 130 extending radially outwardly from the body 128. The body 128 is generally cylindrical, as discussed above for the body 28, by way of example and without limitation, however, the body 128 is reduced in length relative to the flag 130 such that upon inserting the insertion end 128b into the pocket 29, the exposed end 128a of body 128 is flush with, or recessed axially inwardly from the upper end 22 of the shaft 31. Accordingly, the body 128 does not extend axially beyond the upper end 22 of the shaft. However, the flag 130 extends axially beyond exposed end 128a of the body 128, such that the flag 130 extends axially beyond the upper end 22 of the shaft 31 in a direction facing the clamp yoke 24, as discussed above for the flag 30. In the non-limiting embodiment illustrated, an inclined lower portion 60 of the flag 130 extends in inclined relation away from the body 128 in a direction facing the clamp yoke 24, and, a protrusion 62 extends axially from an uppermost region of the flag 130 away from the upper end 22 in a direction facing away from the clamp yoke 24, wherein the added protrusion 62 further facilitates assurance that the shaft 31 is proper inserted into the bore 51 to the proper, predetermined axial extent (FIG. 11). As such, if the shaft 31 is not proper inserted into the bore 51 to the proper, predetermined axial extent, the protrusion 62 will at least partially obstruct the fastener opening(s) 44 in the clamp yoke 24. When shaft 31 is in the proper, fully assembled position relative to yoke 24, the protrusion 62 will be located immediately adjacent fastener opening(s) 44, and could be flush with the wall bounding fastener opening (s), but does not block or otherwise interfere with insertion of the clamp fastener 42 through the fastener opening(s) 44. Accordingly, if shaft 31 is not fully inserted to the proper assembly position, the protrusion 62 will interfere with insertion of the clamp fastener 42 through the fastener opening(s) 44.

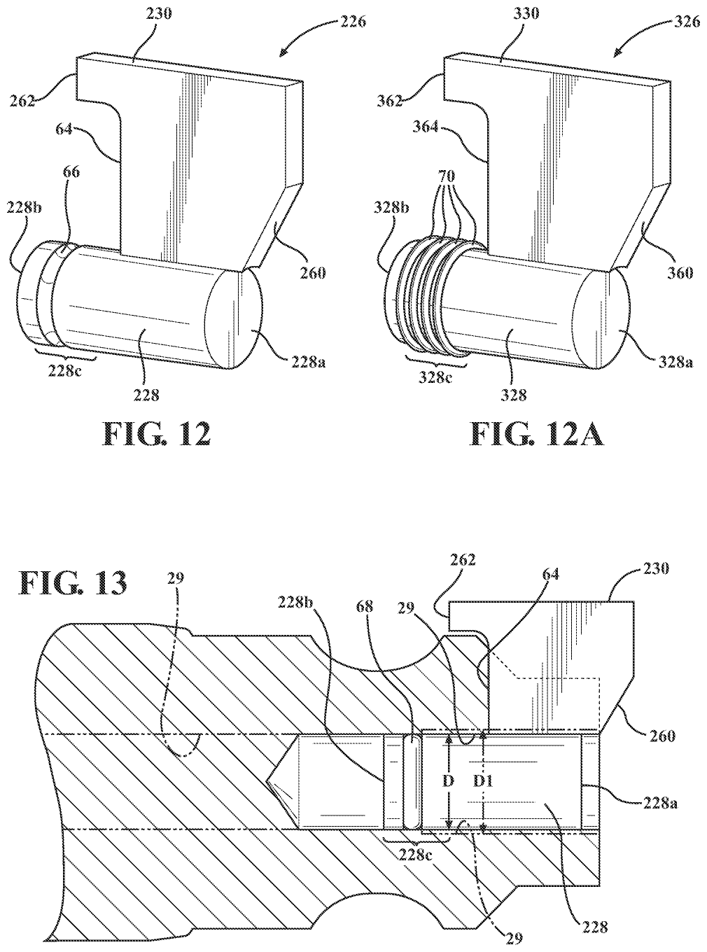

In FIG. 12, a flag device 226 constructed in accordance with another aspect of the disclosure is shown, wherein the same reference numerals, offset by a factor of 200, are used to identify like features of the flag device 226. The flag device 226 is similar to flag device 126, having a body 228 and a flag 230 extending radially outwardly from the body 228. The flag 230 is the same as discussed above for flag 130, including an inclined lower portion 260 and protrusion 262, and thus, the discussion hereafter is directed to body 228. The body 228 is generally cylindrical, as discussed above for the body 128, by way of example and without limitation, however, the insertion end 228b of the body 228 extends axially beyond an insertion end 64 of the flag 230 such that upon being inserted into the pocket 29, the insertion end 228b of body 228 extends axially inwardly into a tight fit with the pocket 29 of the shaft 31. Accordingly, the body 228 closes and seals off the pocket 29 against potential ingress of water. To further prevent the ingress of water into the pocket 29, a portion 228c of the body 228 extending beyond the insertion end 64 of flag 230 can be provided having an annular groove 66 sized for receipt of a seal member 68 therein, such as an O-ring, by way of example and without limitation. The O-ring 68 is sized to form a liquid tight seal between the inner surface of the pocket 29 and the outer surface of the body 228. Further yet, the portion 228c of body 228 can be provided having an increased diameter D relative to the remainder of body 228, with diameter D being sized for an interference press fit in pocket 29, thereby further assuring protection against the ingress of water past flag device 226 into pocket 29. Further yet, as shown in phantom in FIG. 13, the pocket 29 could also be formed having a 2 step diameter, with a first diameter D1 immediately adjacent the upper end 22 of shaft 31 and a second diameter D axially inwardly from the first diameter D1, with the first diameter D1 being sized for a line-to-line or loose fit with body 229 and the second diameter D being less than the first diameter D1 to form an interference press fit with body 228. As such, the 2 step diameter pocket 29 can also contribute to prevent the ingress of water into pocket 29 via the interference fit formed by the reduced second diameter. It is to be recognized that the above mechanisms for preventing ingress of water can be provided individually or in combination with one another, as will be appreciated by a skilled artisan in view of the disclosure herein.

In FIG. 12A, a flag device 326 constructed in accordance with another aspect of the disclosure is shown, wherein the same reference numerals, offset by a factor of 300, are used to identify like features of the flag device 326. The flag device 326 is similar to flag device 126, 226, having a body 328 and a flag 330 extending radially outwardly from the body 328. The flag 330 is the same as discussed above for flag 130, including an inclined lower portion 360 and protrusion 362, and thus, the discussion hereafter is directed to body 328. The body 328 is generally cylindrical, as discussed above for the body 228, by way of example and without limitation, with the insertion end 328b of the body 328 extending axially beyond an insertion end 364 of the flag 330 such that upon being inserted into the pocket 29, the insertion end 328b of body 328 extends axially inwardly into a tight fit with the pocket 29 of the shaft 31. Accordingly, the body 328 closes and seals off the pocket 29 against potential ingress of water. To enhance the sealing of body 328 in sealed relation with pocket 29, one or a plurality of annular ribs 70 are formed about the body 328, wherein the annular ribs 70 are formed on a portion 228c of the body 228 extending beyond the insertion end 64 of flag 230. The rib(s) 70 extend radially outwardly from an outer cylindrical surface of body 328, and are sized for an interference fit with pocket 29. The rib(s) 70 can be formed having any desired shape, such as a smooth, constant radius outer surface, triangular outer surface, rectangular outer surface, or otherwise, and sized to deform in an interference fit against an inner surface bounding pocket 29. The rib 70 can also being formed as a helical thread. Accordingly, the annular rib(s) 70 can be intentionally deformed, also referred to as crushed, to form a fluid tight seal within pocket 29, and further acting as a retention feature to retain flag device 326 in pocket 29. It is to be recognized that the rib(s) 70 for preventing ingress of water and for establishing retention of the flag device 326 in pocket 29 can be provided individually or in combination with the features discussed above with regard to FIG. 12, as will be appreciated by a skilled artisan in view of the disclosure herein.

Manufacture of the above flag devices 26, 126, 226, 326 is economical, in that flag devices 26, 126, 226, 326 can be made of any desired polymeric material, including plastic or rubber, in a molding operation, by way of example and without limitation. Accordingly, the precise size and shape of the flag devices 26, 126, 226, 326 can be readily made in economical fashion.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description.

What is claimed is:

1. A steering shaft assembly, comprising:
a steering shaft extending along a central longitudinal axis between a first end portion a second end portion opposite the first end portion, the first end portion terminating at a first end and the second end portion terminating at a second end, a pocket extending axially into the first end;
a clamp yoke having a through bore sized for receipt of the first end portion of the steering shaft, the clamp yoke having a fastener opening; and
a flag device having a body disposed in the pocket and a flag extending radially outwardly from the body, the flag configured to obstruct the fastener opening in the clamp yoke until the steering shaft is disposed in the through bore to a fully assembled position.

2. The steering shaft assembly of claim 1, further including a slot extending radially outwardly from said recessed pocket, said flag extending through and radially outwardly from said slot.

3. The steering shaft assembly of claim 1, wherein said slot has opposite sidewalls configured to confront said flag to prevent said flag device from rotating relative to said steering shaft about said central longitudinal axis.

4. The steering shaft assembly of claim 2, wherein said flag extends axially beyond said first end.

5. The steering shaft assembly of claim 4, wherein said body is flush with, or recessed axially inwardly from said first end.

6. The steering shaft assembly of claim 4, wherein said body extends axially outwardly from said first end.

7. The steering shaft assembly of claim 1, wherein said pocket extends along said central longitudinal axis.

8. The steering shaft of assembly claim 7, wherein said body is generally cylindrical.

9. The steering shaft assembly of claim 8, wherein said pocket is generally cylindrical.

10. The steering shaft assembly of claim 1, wherein said flag device closes off said pocket against ingress of water.

11. A steering shaft and clamp yoke assembly, comprising:
a clamp yoke having an annular wall with a through bore and a fastener opening configured for receipt of a clamp fastener therein;
a steering shaft extending along a central longitudinal axis between opposite first and second end portions terminating at respective first and second ends, a pocket extending axially into said first end, said first end portion being configured for receipt in said through bore of said clamp yoke; and
a flag device having a body configured for receipt in said pocket and a flag extending radially outwardly from said body, said flag being configured to obstruct said fastener opening until said steering shaft is inserted into said through bore to a predetermined insertion position.

12. The steering shaft and clamp yoke assembly of claim 11, further including a slot extending radially outwardly from said pocket, said flag extending through and radially outwardly from said slot.

13. The steering shaft and clamp yoke assembly of claim 11, wherein said slot has opposite sidewalls configured to confront opposite side of said flag to prevent said flag device from rotating relative to said steering shaft about said central longitudinal axis.

14. The steering shaft and clamp yoke assembly of claim 12, wherein said flag extends axially beyond said first end.

15. The steering shaft and clamp yoke assembly of claim 14, wherein said body is generally flush with, or recessed axially inwardly from said first end.

16. The steering shaft and clamp yoke assembly of claim 11, wherein said pocket extends along said central longitudinal axis.

17. The steering shaft and clamp yoke assembly of claim 16, wherein said body and said pocket are generally cylindrical.

18. The steering shaft and clamp yoke assembly of claim 11, wherein said flag device closes off said pocket against ingress of water.

19. A steering assembly, comprising:
a pinion shaft;
a clamp yoke having an opening for receiving an end of the pinion shaft and having a fastener opening for receiving a fastener that clamps the clamp yoke to the pinion shaft; and
a blocking member having a body disposed within an aperture of the pinion shaft and having a blocking segment extending from the main segment positioned to block the counter bore during an insertion range of the pinion shaft within the central opening and being clear of the counter bore at a predetermined insertion position.

20. The steering assembly of claim 19, further including a slot extending radially outwardly from said aperture, said blocking segment through and radially outwardly from said slot.
